(19) United States
(12) Patent Application Publication
(10) Pub. No.: US 2026/0177121 A1
(43) Pub. Date: Jun. 25, 2026

(54) Disc Brake for a Hoist, Combining a Positive Brake and a Negative Brake

(71) Applicant: Stromag France SAS, La Guerche sur l'Aubois (FR)

(72) Inventor: David Babise, Pougny (FR)

(21) Appl. No.: 18/725,901

(22) PCT Filed: Feb. 7, 2023
(86) PCT No.: PCT/FR2023/050164

§ 371 Date: Jul. 1, 2024

(30) Foreign Application Priority Data
Feb. 7, 2022 (FR) 2201039

(51) Int. Cl. F16D 65/18; F16D 55/00; F16D 55/226; F16D 55/228; F16D 65/097

(52) U.S. Cl. CPC F16D 65/18; F16D 55/226; F16D 55/228; F16D 65/0972; F16D 2055/0016

(57) ABSTRACT

The invention relates to a hybrid brake for a hoist, comprising: an upper plate (2) and a lower plate (3) forming a clamp capable of clamping a disc (1), the upper plate being mounted so as to slide axially in a half-caliper (4); a stack of spring washers (10) arranged in the half-caliper; a negative piston (80) sliding axially in the half-caliper, which can be placed in an open-brake position when a first power source is activated, the negative piston being pushed into a closed-brake position by the stack of spring washers when the first power source is inactive; an axially slidable positive piston (90) which can be placed in a closed-brake position when a second power source is activated, the positive piston being placed in an open-brake position under the effect of a return spring (98) when the second power source is inactive.

### CROSS-REFERENCE TO RELATED APPLICATIONS

This patent application is a national stage application of International Patent Application No. PCT/FR2023/050164, filed on Feb. 7, 2023, which claims the benefit and priority of French Patent Application No. 2201039, filed on Feb. 7, 2022, the entire disclosures of which are incorporated by reference herein in their entirety as part of the present application.

### TECHNICAL FIELD

The present application relates to a disc brake which is particularly suitable for braking large loads (e.g. in excess of several tons and up to 50 t), such as a brake intended to equip an elevator, a gondola lift or a hoist of the crane, bridge crane, etc. type.

### PRIOR ART

An elevator or hoist comprises, on the one hand, a high-speed line comprising a motor (generally with a variable speed drive) and a high-speed shaft driven in rotation by the motor via a coupling system, and, on the other hand, a low-speed line comprising a low-speed shaft and a drum whereupon the suspension cables of the load (elevator car or load to be lifted) are wound, the low-speed shaft being driven in rotation by the shaft of the high-speed line to which it is connected via a reduction gear.

An elevator or hoist needs to be fitted with brakes for a number of functions, including: slowing down and stopping the elevator or hoist as it approaches a stop position (service brake), blocking the elevator each time the doors open, or blocking the hoist when it is in its stop position, that is, when the load is at the desired height (parking brake). The standards also require that the elevator or hoist be equipped with a failsafe brake, also called an emergency brake, to slow down, stop and block the elevator or hoist in the event of a power failure or, more generally, in the event of an emergency of any kind.

Service brakes (high-speed and low-torque) are generally associated with the high-speed line, while failsafe brakes (low-speed and high-torque) are fitted on the low-speed line.

In particular, a failsafe brake is configured to activate when it is no longer supplied with electricity (in the event of a power failure): this is known as a power failure brake or negative brake.

Since the 1960s, disc brakes have become the preferred choice for this application, particularly as their heating properties pose little or no problem. In fact, under the effect of heat, the discs expand radially and not in the direction of their thickness, so that braking torque remains under control.

A failsafe brake generally comprises:
a disc secured to the line to be braked, on both sides of which extend the two plates of a clamp capable of clamping the disc, which plates are fitted with friction pads,
for each plate or for one of the two plates only, a washer spring configured to impose a compression force on said plate so as to push and hold the plates under pressure against the disc and thus close and tighten the clamp,
a hydraulic or electromagnetic or electromechanical actuator configured to, when energized, compress the washer spring so as to move said plate away from the disc to open the clamp and release the disc for rotation.

For elevators, the service and parking brakes must be qualified for 10 million operations, while the failsafe brake must be qualified for 200,000 uses. Similarly, hoist manufacturers often require that the parking brakes and failsafe brakes that they build into their machines be guaranteed for 4 million and 200,000 uses, respectively, even though there is currently no standard requiring this.

Some elevator and hoist manufacturers use a single brake for both service and parking functions. Since this brake is used more frequently and/or for longer periods, its friction pads wear out more quickly, which increases maintenance costs. For the same reasons, brake life is reduced, requiring more frequent replacement. All this means downtime for the elevator or hoist, which can be unpleasant for users (in the case of domestic elevators) or costly for the company (in the case of non-standard hoists or elevators used in industry).

Other manufacturers of elevators and other hoists use the failsafe brake as a parking brake, which means that the failsafe brake must be oversized to qualify for 4 or 10 million uses instead of 200,000, that is, the number of failsafe brake washers must be multiplied to compensate for any washer breakage that may occur during multiple uses of the brake. This results in a larger brake footprint and higher manufacturing costs.

Disc brakes are also used in the automotive industry. U.S. Pat. No. 3,647,030 discloses a motor vehicle brake which has the special feature of combining a negative washer actuator as described previously with a positive actuator.

The positive actuator is formed by a first piston slidably mounted in a housing and a first chamber capable of receiving a pressurized liquid, the increase in liquid pressure in said first chamber causing the piston to move in the brake application direction. The return of this first piston (to open the brake when the brake pedal is released) is provided by an elastically deformable seal, housed in a groove between the outer peripheral face of the piston and the housing, as explained in patent U.S. Pat. No. 3,377,076 incorporated by reference in U.S. Pat. No. 3,647,030.

The negative actuator is formed by a second piston and a second chamber which can receive a pressurized liquid, whereby an increase in liquid pressure in the second chamber causes the brake to open. The second piston has a collar whereupon a stack of spring washers rests. When a liquid pressure failure occurs in the circuit, the pressure in the second chamber drops and the stack of spring washers can relax and push the second piston, which in turn pushes the first piston, causing the brake to close. Maintaining high pressure in the second chamber neutralizes the brake formed by the second piston.

Such a brake has the advantage of combining, in a single device, a positive actuator serving as a service brake and a negative actuator serving as an emergency brake. This combination qualifies it as a hybrid brake. But it has the following drawbacks.

Firstly, the travel (opening) of the brake of U.S. Pat. No. 3,647,030 remains limited to a few millimeters. This brake therefore cannot be used with large discs, making it unsuitable for hoists.

Hoists require large-diameter brake discs (up to several meters in diameter), unlike motor vehicles, whose discs have a diameter of around 250 mm. Because of their large diameter, hoist discs can have a run-out of several millimeters, which is incompatible with the use of a brake with a travel of the same order of magnitude (it is important that the brake linings do not rub the disc when the brake is in the open position; additionally, in the closed position, the braking force applied by the linings to the disc must be controllable and not dependent on the angular position of the disc).

Furthermore, given the design of the brake of U.S. Pat. No. 3,647,030, in the event of a failure of its positive actuator, such as a brake fluid leakage problem, it is necessary to remove the brake and dismantle it completely in order to repair it. As this is a motor vehicle brake, this is not a problem per se. For a hoist brake, however, whose weight and size are far greater than those of a motor vehicle brake, it would be valuable to be able to intervene in situ and repair the brake without having to remove it.

DE 3509042 discloses another hybrid brake with similar drawbacks to U.S. Pat. No. 3,647,030.

### PRESENTATION OF THE INVENTION

In the following, the term “hoist” covers both industrial hoists such as cranes, bridge cranes, etc., and elevators, whether for industrial or domestic use.

The aim of the invention is to overcome at least one of the above-mentioned disadvantages by offering a brake suitable for hoists, which can be used simultaneously as a parking brake and an emergency brake, or even as a service brake if lifting standards evolve in this direction, without sacrificing safety, the compactness of the brake or its simplicity of design, and without increasing its manufacturing and maintenance costs.

In particular, the invention aims to provide a hybrid brake with significant travel for use with large-diameter discs, for example discs from one to several meters in diameter.

Another aim of the invention, in a preferred embodiment, is to be able to convert an existing failsafe brake into a hybrid brake easily and cost-effectively. A further objective of the invention, in a preferred embodiment, is to propose a maintenance-friendly hybrid brake for a hoist.

To achieve the above-mentioned objectives, the invention proposes a hybrid brake for a hoist, intended to cooperate with a disc of the hoist extending in a plane orthogonal to an axial direction, the hybrid brake comprising:
two plates extending parallel to the disc on both sides thereof, the two plates forming a clamp operable between an open-brake position where the plates are at a distance from the disc and a closed-brake position where the plates clamp the disc,
a rigid body comprising an upper tubular part, called upper half-caliper, located on one side of the disc, one of the plates, called upper plate, being carried by a shoe mounted to slide in the axial direction in a central through recess in the upper half-caliper,
a stack of spring washers arranged in the central recess of the upper half-caliper about a central axis parallel to the axial direction, the stack of spring washers being compressible beyond a level, called emergency braking compression, wherein said stack exerts a force on the shoe corresponding to a desired emergency clamping force on the disc,
a negative actuator, comprising a negative piston driven by a first power source, which negative piston has a face whereupon a lower end of the stack of spring washers rests, the negative piston being mounted so as to slide in the axial direction in the central recess of the upper half-caliper between an upper, open-brake position where the negative piston compresses the stack of spring washers beyond the emergency braking compression, and a lower, closed-brake position, wherein the brake is closed and wherein the negative piston holds the stack of spring washers at the emergency braking compression on one side and bears directly or indirectly on the shoe on the other side, the negative piston being placed in its upper open-brake position when the first power source is activated and in its lower closed-brake position when said first power source is inactive (either because there is a power failure or because the first source is not activated or is voluntarily deactivated),
a positive actuator comprising a positive piston driven by a second power source, the positive piston being axially slidable between an upper open-brake position (wherein the brake is open) and a lower closed-brake position (wherein the brake is closed and more or less applied), the positive piston being in its upper open-brake position when the second power source is inactive and being movable to its lower closed-brake position when the second power source is activated.

The hybrid brake according to the invention is characterized in that it comprises a positive piston return spring, configured to return the positive piston to its upper open-brake position.

In the event of an emergency, the negative actuator is deactivated and the brake is closed with a desired emergency clamping force, which is determined by the spring washer stack structure.

The positive actuator can be used as a parking brake, or even as a service brake subject to the development of standards in this respect, and as such it must be dimensioned so as to be qualified for around one million operating cycles (it is preferably qualified for several million, e.g. at least 10 million, operating cycles). The positive actuator can also be used for short-term static load holding (short-term parking brake, when the installation is energized, with the negative actuator always on standby to ensure load safety).

Due to its design, the negative brake is automatically activated in the event of a power failure (second power source unavailable and negative actuator inactive). The negative brake can also be used actively for dynamic emergency braking (in the event of any fault) and for long-term static load holding (long-term parking brake, e.g. when the system is taken out of service). The stack of spring washers, which constitute the negative brake's energy reserve for emergency braking, must therefore be dimensioned so as to be qualified for 200,000 operating cycles. Since the negative brake is not used as a service brake, the stack of spring washers does not need to be dimensioned for several million cycles, which limits its size and cost.

Owing to the return spring, the positive piston can be moved over a much longer stroke than the positive piston of U.S. Pat. No. 3,647,030, for example. In other words, the brake can have a much larger opening, making it compatible with a large-diameter disc in a hoist. In a preferred version:
the negative piston comprises an upper cylindrical cavity receiving a lower portion of the stack of spring washers, the negative piston further comprising a lower end configured to bear directly or indirectly on the shoe when the negative piston is in the lower position, so that the pressure exerted by the stack of spring washers on the bottom of the piston cavity is transmitted to the shoe (when the negative piston is in the lower position),
the positive piston comprises a shaft extending along the central axis through the stack of spring washers, which shaft has a lower end configured to mate with the shoe and an upper end which projects from the upper half-caliper regardless of the position of the positive piston.

We therefore have a configuration which, in a way, is “reversed” compared with the one proposed by U.S. Pat. No. 3,647,030 (where the central shaft corresponds to the negative piston and not the positive piston). This configuration offers two main advantages.

In the first instance, such a brake can be obtained from an existing failsafe brake, which comprises only a negative actuator formed by a negative piston bearing directly or indirectly on a shoe, and a stack of spring washers resting on one face of said negative piston. A positive actuator can easily be formed from a shaft-shaped piston (with a lower end suitable for mating with the shoe) and a cover fitted over the half-caliper. A central hole is arranged in the bottom of the negative piston if required, and the shaft can easily be inserted into the central hole of the spring washers and said negative piston. The cover is also designed to accommodate the means for actuating the shaft (positive piston) along the central axis.

Secondly, this brake is advantageous in that its positive actuator, which as a service brake is the actuator most frequently used and therefore most likely to fail, is directly accessible from an upper outer face of the half-caliper, without the need to dismantle any other major part of the brake, such as the negative actuator for example, and without the need to remove the hybrid brake. This facilitates any maintenance and repair of the positive actuator. They can be carried out in situ, without removing the brake, which is particularly useful when the brake is very large and/or heavy. Additionally, the power source and the means of activating the positive piston can be arranged at the top of the half-caliper or above it (for example, in a cover over the half-caliper), so that they too are easily accessible. This facilitates maintenance and repair operations, and reduces maintenance costs.

According to a possible feature of the invention, the first power source (power source of the negative actuator) is hydraulic, the negative piston having an outer shoulder which is oriented toward the disc and which delimits, in the central recess of the half-caliper, a chamber called the negative hydraulic chamber. Filling said negative hydraulic chamber with fluid from the first power source therefore exerts pressure on said shoulder away from the disc, causing the negative piston to move away from the disc.

Alternatively, the first power source can be electromagnetic or electromechanical.

According to a possible feature of the invention, the second power source (power source of the positive actuator) is hydraulic or electromechanical or electromagnetic.

Conventionally, each plate is fitted with one or more friction pads. According to a possible feature of the invention, the brake comprises a wear compensation device between the stack of spring washers and the shoe to compensate for friction pad wear.

Advantageously and according to the invention, this wear compensation device comprises:
an external thread called the external compensation thread on the positive actuator shaft between the lower end of the stack of spring washers and the lower end of the shaft,
shells, called compensation shells, arranged around the external compensation thread, each compensation shell having an internally threaded face complementary to the external compensation thread,
for each compensation shell, a housing made in the negative piston and wherein said shell is housed, the housing having an axial dimension greater than an axial bulk of the compensation shell increased by at least one external compensation thread pitch so that the compensation shell can move axially in this housing over an axial distance of at least one external thread pitch, the housing also having a radial depth sufficient for the shell to move radially over a radial distance corresponding at least to the depth of the external thread pitch so that the internal thread of the shell can disengage from the external compensation thread,
an elastic ring surrounding the shells and exerting a centripetal radial pressure thereupon, tending to keep the compensation shells pressed against the external compensation thread. For example, the elastic ring rests on an outer peripheral face of the shells opposite their internally threaded face.

According to a possible feature of the invention, there are three compensation shells, uniformly distributed around the external compensation thread, that is, arranged on radii forming angles of 120° with one another.

According to a possible feature, the wear compensation device further comprises an actuator configured to drive the positive piston in rotation and means for controlling said actuator.

Wear compensation can thus be carried out not only automatically by pitch change, as explained later in the detailed description referring to the appended figures, but also in a controlled manner by rotation of the positive piston (and therefore of the external compensation thread) by the aforementioned dedicated actuator.

The hybrid brake according to the invention can be a sliding brake or a symmetrical brake.

If the hybrid brake according to the invention is a sliding brake:
in addition to the upper half-caliper, the rigid body of the brake comprises a lower part, called the counter-caliper, located on the other side of the disc, the other plate, called the lower plate, being located on this counter-caliper and being fixed relative thereto,
the brake has no actuator for braking on the counter-caliper side; it therefore preferably comprises only the negative actuator and the positive actuator previously defined, which are arranged in the upper half-caliper,
the brake comprises a column whereupon the rigid body (half-caliper+counter-caliper) is mounted so as to slide in the axial direction.

If the hybrid brake according to the invention is a symmetrical brake:
in addition to the upper half-caliper, the rigid body of the brake comprises a lower half-caliper, located on the other side of the disc,
like the upper plate, the lower plate is supported by a lower shoe mounted so as to slide in the axial direction in a central recess in the lower half-caliper,
the brake comprises a second positive actuator and a second negative actuator arranged in the lower half-caliper and configured to move the lower shoe. The second negative and positive actuators can be identical, respectively, to the negative and positive actuators of the upper half-caliper, but arranged symmetrically (with respect to the braking plane represented by the disc) in the lower half-caliper. In short, the brake assembly can be symmetrical in relation to the disc.

The invention extends to a braking system comprising a hybrid brake as previously defined and a microprocessor controller to which the positive and negative actuators of said hybrid brake are connected, the controller being configured to use the positive actuator for all dynamic service braking and for all static holding when the hoist is in service, powered on and in the absence of a fault (“short-term” static holding), and to use the negative actuator for any emergency dynamic braking and for any static holding (“long-term”) when the hoist is taken out of service (that is, it is no longer powered on), the negative actuator also being, by design, automatically triggered without controller action for any emergency dynamic braking in the event of a power failure.

The invention extends to a hoist characterized in that it is equipped with a hybrid brake as previously defined. In the preceding sentence, the expression “a hybrid brake” should not be understood as meaning “one and only one” hybrid brake, but as meaning “at least one” hybrid brake, that is, one or more hybrid brakes.

### BRIEF DESCRIPTION OF THE DRAWINGS

The invention, according to an embodiment, will be well understood and its advantages will become clearer on reading the following detailed description, given by way of indication and in no way limitingly, with reference to the appended drawings, wherein:

FIG. 1 is an axial cross-section of one embodiment of a hybrid brake according to the invention;

FIG. 2 is a symbolic depiction of the hybrid brake shown in FIG. 1;

FIG. 3 is a symbolic depiction of a wear compensation device that can be fitted to a hybrid brake according to the invention, showing the brake with new friction pads and with the positive piston in the upper open-brake position, and the negative piston in the upper position;

FIG. 4 is a symbolic depiction of the wear compensation device shown in FIG. 3 with new friction pads and with the positive piston in the lower closed-brake position and the negative piston in the upper position;

FIG. 5 is a symbolic depiction of the wear compensation device of FIG. 3 to 5 in the case of worn friction pads, simulating the closing of the positive brake, that is, the descent of the positive piston toward the disc from its upper position, the negative piston being unused and therefore fixed in the upper position;

FIG. 6 is a symbolic depiction of the wear compensation device shown in FIG. 5 (with worn friction pads), simulating the opening of the positive brake, that is, the upward movement of the positive piston away from the disc, after braking subsequent to the situation shown in FIG. 5, with the negative piston still fixed in the upper position.

### DETAILED DESCRIPTION

Identical elements shown in the above figures are identified by identical numerical references.

Throughout the description, the brake is defined and disclosed in the position where it appears in the appended figures. The terms “top”, “bottom”, “upper”, “lower”, “above”, “below”, “up”, “down”, etc., refer to this position and have nothing to do with the direction of gravity, as the brake can operate in any position. Thus for example, since the brake is disclosed in a position where its actuators are located above the disc, the expression “the piston moves down” is used to mean more generally that the piston in question moves in the direction of the disc (which does not mean that it necessarily follows the direction of gravity), while the expression “the piston moves up” means that the piston moves away from the disc.

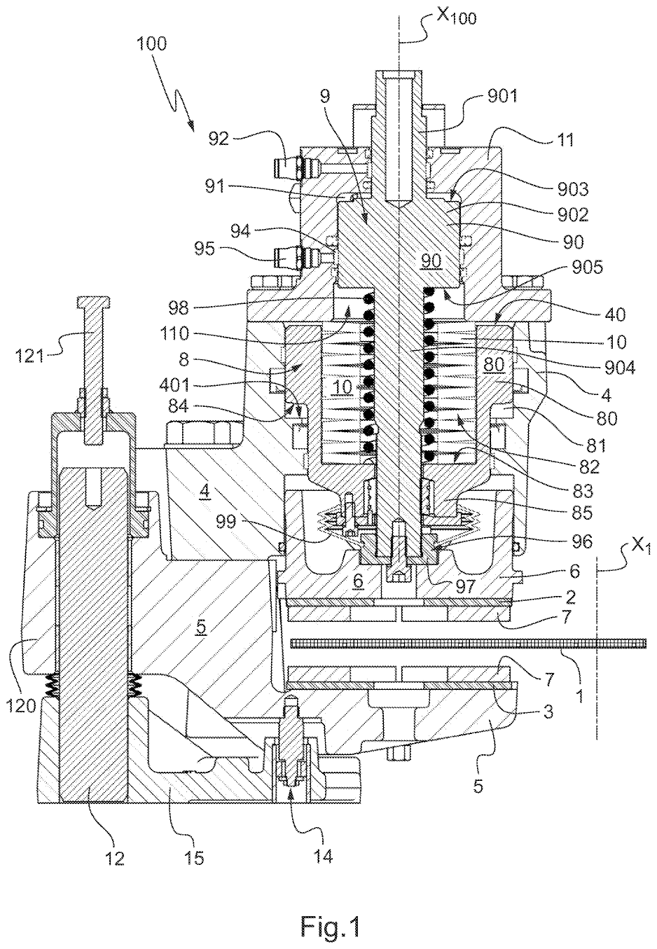

FIG. 1 shows a hybrid brake 100 according to the invention, seen in cross section in an axial plane (plane containing the central axis of the brake body). More specifically, the axial plane in question is a plane of symmetry of the brake.

The hybrid brake 100 is associated with a disc 1 of a hoist (not shown), which disc is secured to a rotating line of said hoist. The hybrid brake 100 comprises an upper plate 2 fitted with friction pads 7 (also known as wear liners) and a lower plate 3, likewise fitted with friction pads 7. The plates and the disc are parallel to one another and orthogonal to a central axis X₁₀₀ of the brake, the reference X₁ also designating the axis of rotation of the disc 1, which is parallel to the central axis X₁₀₀. The term “axial direction” refers to the direction of the central axis X₁₀₀ of the brake.

The hybrid brake 100 further comprises a rigid body comprising an upper half-caliper 4, hereinafter simply referred to as “half-caliper”, and a counter-caliper 5. The half-caliper 4 is tubular: it comprises a central recess 40 passing through in the axial direction. This central recess 40 is not necessarily cylindrical, and may comprise a succession of sections of different diameters forming various inner shoulders. Conversely, for reasons of economy, these various sections preferably all have a circular cross section, so that seals and guides can be produced using conventional seals. Other cross sections (e.g. polygonal, especially square) are also possible, provided specific seals of complementary shape are used.

The plate 2 is supported by a shoe 6 slidably mounted inside the central recess 40 of the half-caliper (alternatively, the plate 2 could correspond to the lower face of said shoe 6), while the plate 3 is supported by the counter-caliper 5 (for example, it is attached to the upper face thereof).

The hybrid brake 100 also comprises a stack of spring washers 10. The spring washers are chosen for their dimensional characteristics/material/properties (stiffness in particular), just as the liners are chosen for their coefficient of friction, based in particular on the maximum load the brake is designed to brake. The stack of spring washers is thus dimensioned to generate a clamping force, called the emergency clamping force, inducing (via the pads and therefore according to their coefficient of friction) a braking force which must correspond to the braking force required to instantly stop said maximum load.

The hybrid brake 100 also comprises both a negative actuator 8 and a positive actuator 9, which, together with the stack of spring washers 10, form a negative brake and a positive brake, respectively.

The hybrid brake 100 shown is a sliding brake: the two actuators are located on the same side of the disc 1; they both act on the upper plate 2, and the brake has no actuator on the other side of the disc. The upper plate 2 can be moved toward or away from the disc by the actuators, while the lower plate 3 remains stationary. In order for the two plates to exert a clamping force on the disc, the rigid body of the brake must be able to move axially. To this end, the brake comprises a column 12 whereupon the rigid body of the brake (half-caliper 4+counter-caliper 5) is slidably mounted in the axial direction, by means of a bracket 120 which, in this example, extends the counter-caliper 5, the bracket 120 and the column 12 thus forming a sliding connection. The column 12 is attached to a base plate 15. The brake 100 also comprises a screw 121 for locking the rigid body to the column 12 if necessary, particularly during maintenance operations.

Alternatively, the hybrid brake could be a symmetrical brake. It would then comprise four actuators, namely a positive actuator and a negative actuator on each side of the disc. The sliding brake is preferred because it offers lower manufacturing and maintenance costs, as well as greater reliability (fewer actuators, less risk of failure or breakage).

The negative actuator 8 comprises a negative piston 80 slidably mounted in the central recess 40 of the half-caliper.

The example shown uses a hydraulic negative actuator 8. A chamber 81 (called the negative chamber) is therefore provided, which negative chamber 81 is delimited by the inner face of recess 40 and the outer face of the negative piston. More specifically, the negative chamber 81 is delimited by an outer shoulder 84 of the piston pointing downwards (that is, toward the disc 1) and an inner shoulder 401 of the half-caliper pointing upwards (that is, away from the disc 1). Of course, this negative chamber 81 is connected to a pressurized fluid supply device (not shown) which constitutes the power source (called first power source), therefore hydraulic, provided for the operation of the negative actuator 8.

Alternatively, the negative actuator could be electromechanical or electromagnetic, a person skilled in the art being able, without any inventive step, to adapt the shape of the half-caliper and to integrate, for example, the electromagnets required to move the negative piston to its upper position when the electromagnets are energized for the realization of an electromagnetic negative brake.

The negative piston 80 has an upper cavity 82 wherein a lower part of the stack of spring washers 10 is housed. The lower end of the stack 10 thus rests on a bottom 83 of the upper cavity 82. The upper end of the stack of spring washers 10 also comes into abutment against a fixed element of the rigid body of the brake, in this case the underside of a cover 11 attached to the top of the half-caliper 4.

The presence of the cover facilitates maintenance operations by allowing access to the interior of the half-caliper and, above all, to the stack of spring washers 10: to change a broken spring washer, for example, simply unscrew the screws that pass through the lower flange of the cover 11 and attach the latter to the half-caliper 4, then remove the cover to gain access to the stack of spring washers 10 housed in the upper cavity 82 of the negative piston. This cover also provides easy access to the positive piston 90, disclosed in detail below.

The central recess 40 of the half-caliper extends axially into a central recess 110 which passes through the cover 11 in the axial direction.

As the stack of spring washers 10 is wedged between the underside of the cover 11 (which is fixed) and the bottom 83 of the upper cavity of the negative piston 80, the compressive force of the stack of spring washers 10 tends to move the negative piston 80 downwards, toward the shoe 6.

When the chamber 81 of the negative actuator is empty, or when little or no pressure is exerted on the fluid contained in said chamber, the negative piston 80 descends under the effect of the thrust of the stack of spring washers 10; the lower end 85 of the negative piston 80 bears, directly or indirectly, on a stop or ball joint 97 carried by the lower end of the positive piston 90; the stop or ball joint 97 is coupled to the shoe 6 and the negative piston pushes the shoe 6 toward the disc 1 as the stack of spring washers 10 expands.

When the friction pads 7 of the plate 2 come into contact with the disc 1, the rigid brake body slides upwards as a unit along the column 12, while the negative piston 80 continues to descend relative to the half-caliper, until the negative piston 80 is in a low, closed-brake position where the friction pads of both plates are in contact with the disc and together exert a pinching force on the disc. The clamping force, called emergency clamping force, then imposed on the disc depends on the residual compression of the stack of spring washers 10 in this low position of the negative piston, a residual compression which can be adjusted during brake design by modifying the number, stiffness, material and/or dimensions of the washers used. In this way, the desired emergency clamping force can be achieved.

When the negative piston 80 is in the upper position as shown in FIG. 1, that is, when the chamber 81 is filled with a fluid pressure greater than or equal to a given threshold value, the spring washer stack 10 is compressed beyond the emergency braking compression (which corresponds to the lower position of the piston 80).

In the event of a power failure or if the fluid supply to the chamber 81 is deliberately cut off, that is, if the (first) power source for the actuator 8 is inactive (or deactivated), the pressure in the chamber 81 drops abruptly and the chamber empties; the negative piston 80 drops to its lower position and the brake is closed in a fraction of a second. The actuator 8 is therefore a negative actuator.

The positive actuator 9 in turn comprises a positive piston 90 slidably mounted in the central recesses 40 and 110 of the half-caliper and the cover.

In the example shown, the positive actuator 9 is also hydraulic. It therefore comprises a chamber 91 (called positive chamber) provided above an upward-facing face of the positive piston 90 (opposite direction to the disc), which chamber is supplied with fluid via a supply duct 92. This fluid constitutes a second power source, enabling operation of the positive actuator 9.

The positive piston 90 comprises, from top to bottom, a first section 901 of smaller diameter and then a second section 902 of larger diameter, so that an outer shoulder 903 pointing upwards (that is, away from the disc 1) is formed between the first and second piston sections.

The positive chamber 91 of the positive actuator is delimited by the outer face of the positive piston 90 and by the inner face of the recess 110 of the cover 11 above this outer shoulder 903. In other words, the positive chamber is formed inside the cover 11, outside the half-caliper 4. It can be seen that the entire positive actuator 9 (piston 90, chamber 91, duct and valve 92 supplying fluid to the chamber, return spring 98) is accessible simply by opening the cover 11. This facilitates maintenance operations (checking and repairing any leaks, for example) on the positive actuator, which is the one most frequently used and therefore most likely to wear out. Similarly, the stack of spring washers 10 (which are susceptible to breakage) is accessible once the cover 11 and the piston 90 have been removed. Thus, the main hybrid brake failures can be rectified on site, without having to remove the brake.

The external diameter of the second section 902 of the positive piston is substantially equivalent (with clearance reduced to a minimum) to the internal diameter of a corresponding section of the central recess 110 of the cover, to allow sliding of the piston 90 along the central axis X₁₀₀ while avoiding fluid leaks that may occur from the chamber 91 between the outer face of the piston and the inner face of the recess 110 of the cover. A seal can be provided to limit such leakage, along with a slot 94 and a duct 95 for collecting any leakage downstream of (that is, below) the seal.

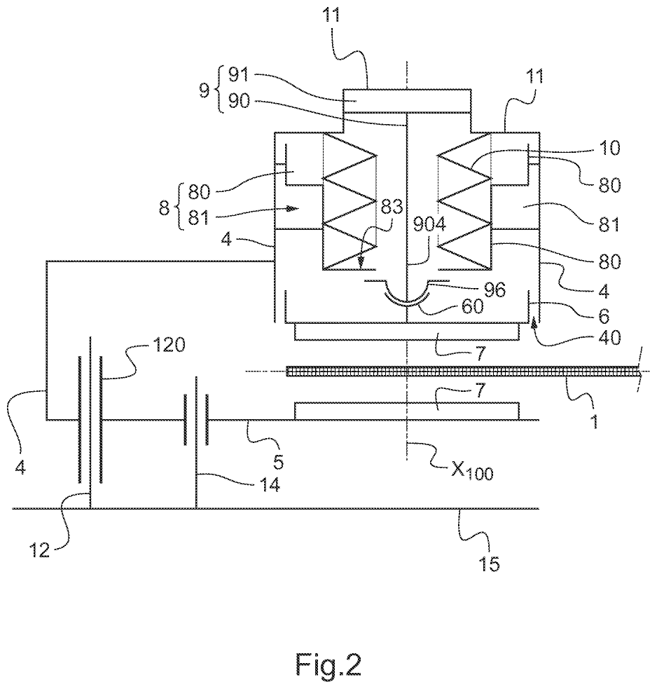

The positive piston 90 then comprises a third section forming a shaft 904 which passes through the stack of spring washers 10 (the shaft 904 passes through the central hole in each of the spring washers); the shaft 904 also passes through the lower end 85 of the negative piston 80. As already mentioned above, the lower end of the positive piston shaft 904 is provided with a stop (FIG. 1) or a ball joint (FIG. 2), referenced 97 in both cases, which engages in a corresponding niche 60 in the shoe 6 when the positive piston 90 is moved downwards toward the disc 1. It should be noted that the lower end 96 of the piston may have no ball joint or stop and be configured for direct coupling to the shoe 6.

A bellows 99, attached on the one hand to the outer face of the lower portion 85 of the negative piston and on the other hand to the lower end 96 of the positive piston (for example to the stop or ball joint 97), is advantageously provided to prevent the entry of dust and liner particles which could disturb the wear compensation system.

The hybrid brake 100 is also associated with a controller (not shown) which controls the positive 9 and negative 8 actuators, acting on the power supply to these actuators.

When dynamic service braking or static parking braking is required, the controller controls the injection of pressurized fluid into the positive chamber 91 (activation of the second power source) of the positive actuator 9, causing the positive piston 90 to move downwards, until the stop or ball joint 97 at the lower end of the shaft 904 engages with the shoe 6 and then pushes the latter toward the disc 1. When the friction pads 7 of the plate 2 come into contact with the disc 1, the rigid brake body slides upwards as a unit along the column 12, while the positive piston 90 continues to descend relative to the half-caliper, until the friction pads of both plates are in contact with the disc and together exert a pinching force on the disc. The clamping force then imposed on the disc 1 is based on the fluid pressure prevailing in the positive chamber 91. The positive brake can therefore be controlled to exert a variable, controlled clamping force.

During this time, the negative brake 8 is kept open as shown in FIG. 1, that is, a fluid pressure at least equal to a predetermined threshold pressure (suitable for compensating the emergency braking compression of the stack 10) is maintained in the negative chamber 81 so that the negative piston 80 remains in the upper position as shown in FIG. 1.

According to the invention, the brake 100 comprises a return spring 98 configured to return the positive piston 90 to its upper open-brake position. In the example shown, the return spring 98 is housed around the shaft 904 inside the stack of spring washers 10. The return spring 98 is supported, on the one hand, on the bottom 83 of the upper cavity of the negative piston and, on the other hand, on an outer shoulder 905 of the positive piston, which shoulder 905 is located at the junction between piston sections 902 and 904 (the shoulder 905 therefore faces downwards).

The return of the positive piston 90 by this spring 98 results in significant travel of the positive piston, which makes the hybrid brake according to the invention suitable for hoists with a large-diameter disc.

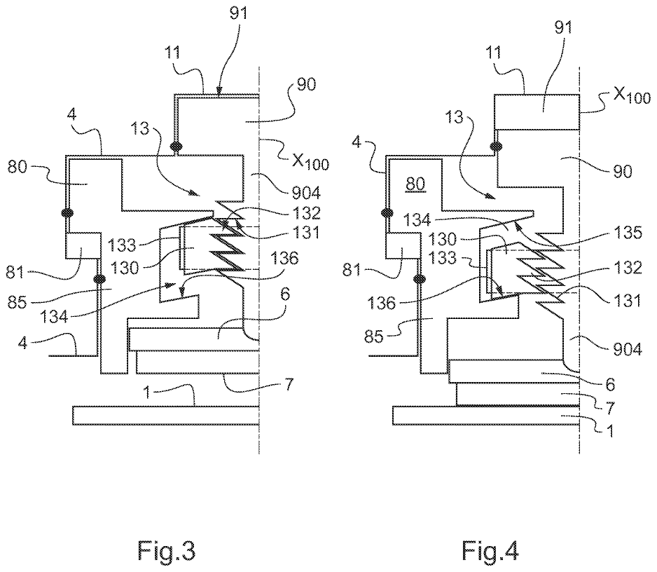

The hybrid brake 100 shown also comprises a wear compensation device 13 arranged between the stack of spring washers 10 and the shoe 6, and which will now be disclosed with reference to FIG. 3 to 6, where only one half of the brake's positive and negative actuators is shown symbolically, the other half being obtained by symmetry with respect to axis X₁₀₀.

The wear compensation device 13 comprises:
an external thread 131, referred to as an external compensation thread, on a lower portion of the positive piston shaft 904,
a plurality of shells 130, for example three shells 130 arranged at 120° relative to one another around the external thread 131,
an elastic ring 133 surrounding the shells and exerting centripetal radial forces thereupon which hold the shells in contact with the external compensation thread 131; each shell 130 has an inner face 132 (face facing the axis X₁₀₀) which has an internal thread with a thread pitch complementary to the thread pitch of the external compensation thread 131, so that the internally threaded inner face 132 of the shells fits into the external compensation thread 131, under the pressure of the elastic ring 133.
for each shell 130, a housing 134 receiving said shell (the housing being specific to said shell or common to several shells), which housing 134 is provided in the negative piston 80 and is open toward the central axis X₁₀₀, the housing 134 having an axial dimension greater than that of the shell so that the shell can move axially in the housing over a distance at least equal to the pitch of the external thread 131, the housing 134 also having a radial depth sufficient for the shell to move radially over a distance enabling the internal thread 132 to emerge from the external thread 131. Note that the compensation device 13 may comprise a plurality of separate housings 134, in particular one housing per shell 130, or a single circular housing which runs around the shaft 904 (that is, a circular slot formed in the inner face of the negative piston 80) and accommodates all the shells 130, or a plurality of housings each accommodating several shells.

In FIGS. 3 and 4, the brake has friction pads 7 which are not worn. In FIG. 3, the negative piston 80 is in the upper open-brake position as shown in FIG. 1 (the negative chamber 81 contains pressurized fluid exerting a force on the piston 80 greater than the emergency braking compression force). The positive piston 90 is also in the upper open-brake position (positive chamber 91 is empty and shoulder 903 (see FIG. 1) of the piston 90 is in contact with or proximate to the cover 11). In this position, each shell 130 rests against the upper face 135 (or upper stop) of its housing 134.

When the positive actuator 9 is actuated, for example for a service operation, the positive piston 90 is pushed downwards by the pressurized fluid injected into the positive chamber 91, and the positive piston 90 moves from its upper position (FIG. 3) to its lower closed-brake position, shown in FIG. 4. Meanwhile, the negative piston 80 is held stationary in its upper, open-brake position.

When the positive piston 90 is in the lower position, the friction pads 7 are in contact with the disc 1. As the piston, and therefore the external thread 131, descend, the shells follow until coming to rest against the bottom face (or bottom stop) 136 of the housing. If necessary, the external thread can be lowered slightly further than the shells (as shown in FIG. 4), pushing the shells radially, but not to the point where the internal thread 132 on the shells disengages from the external thread 131.

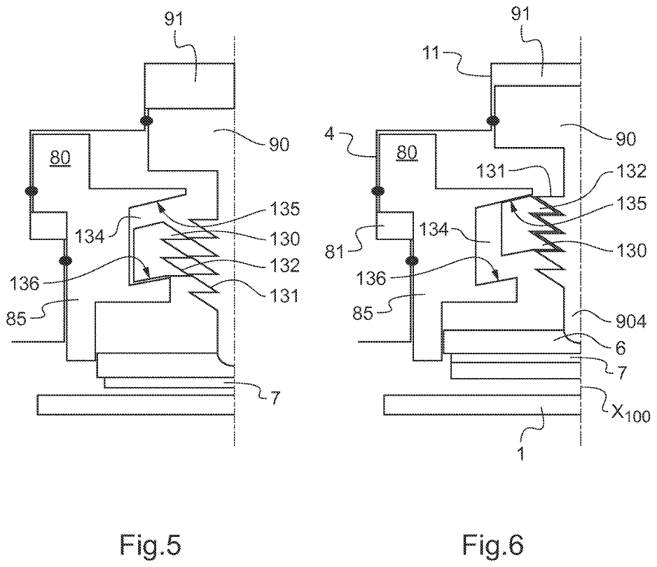

FIG. 5 shows the positive piston 90 in the downward phase, but in the case where the friction pads 7 are worn. In this case, when the positive piston 90 reaches the height shown in FIG. 4 (which corresponds to the lower closed-brake position when the pads are new), the (worn) pads 7 are still at a distance from the disc 1, since they have a reduced thickness due to wear, and the piston can continue to descend, pushed by the pressurized fluid in the positive chamber 91. The shells 130 can no longer descend, held back by the lower face 136 (or lower stop) of the housing. They are then forced to move radially, pushed by the external thread 131, until their internal thread 132 disengages from the external thread 131.

It should be noted that the threads of the external compensation thread 131 and the internal thread 132 of the compensation shells advantageously have a triangular cross section with an upper face orthogonal to the central axis X₁₀₀ and an inclined lower face. Thus, when the positive piston 90 moves downwards, the external compensation thread exerts a force on the compensation shells 130 which comprises both an axial component that pulls the shells downwards and a radial component that tends to move the shells radially outwards when they come into abutment against the lower face 136 of the housing. Conversely, when the positive piston 90 moves upwards, the external compensation thread 131 exerts a purely axial force on each shell 130, which ensures that the internal thread 132 of the shells remains engaged in the external compensation thread 131 of the shaft, even when the shells abut against the upper face 135 of the housing.

Once in the position shown in FIG. 5, the piston 90 continues to descend and the shells skip one or more pitches of the external thread 131 to reach the position shown in FIG. 6. When the positive brake power source is then deactivated or reduced, the piston 90 moves upwards until the shells come into abutment against the upper face (or upper stop) 135 of the housing, thus stopping the piston 90 in a new upper open-brake position (FIG. 6). This new upper open-brake position is offset by one or more external thread pitches 131 from the previous upper position, the offset corresponding to the thickness lost through wear by the friction pads 7. Thus, with the same stroke, actuation of the positive piston 90 still closes the brake, whether the pads are worn or not.

The compensation is also useful for the negative brake, since when the positive brake is not in use and the negative piston 80 is in the upper open-brake position (see FIG. 3 and FIG. 5), the shells are still in contact with the upper face 135 of the negative piston housing 134. However, in the example disclosed, the negative piston 80 acts (that is, indirectly comes to bear) on the shoe 6 via the compensation device 13, more specifically via the shells 130, the external compensation thread 131 and the lower end 96 of the shaft 904. Thus, when the negative piston 80 is in the upper open-brake position, the lower end of the negative piston is already in indirect “contact” with the shoe via the shells 130 and the positive piston shaft 904. When the emergency brake is triggered, the negative piston 80 immediately pushes the shoe 6 toward the disc. Since the relative position of the shells 130 and the external thread 131 takes account of the thickness of the friction pads 7 and any wear, brake closure (with a predetermined emergency braking torque) is guaranteed with the same stroke of the negative piston 80, whether the pads are worn or not.

The presence of a positive brake in the hybrid brake in no way disrupts the emergency braking function. The negative piston 80 can be actuated (lowered) regardless of the position of the positive piston 90. If the positive piston 90 is in the upper open-brake position, as previously disclosed, the negative piston 80 drives the shells 130 and the shoe 6 from the start of its stroke. If the positive brake is in use and the positive piston 90 is, for example, in the lower closed-brake position, the negative piston 80 will only press on the shells 130 and the shoe 6 at the end of its stroke, to ensure that the torque imposed on the disc is at least equal to the emergency braking torque. If the positive brake is in use and the positive piston 90 is in an intermediate position (during lowering or raising), the negative piston 80 will take over at an intermediate point of its own stroke when the upper face 135 of the housings 134 comes into contact with the shells 130. It should be noted that, even if it is in the ascent phase, the positive piston 90 offers no resistance to the descent of the emergency negative piston, since the ascent of the positive piston takes place at negative energy (chamber 91 empties) and the return spring 98 that pushes the positive piston upward bears on the negative piston 80 (the spring 98 therefore exerts a downward force on the negative piston 80 that compensates for the upward force exerted on the negative piston 80 by the positive piston 90 via the shells of the compensation device).

Lastly, the hybrid brake 100 preferably also comprises a recentering device 14, which recenters the brake body relative to the disc to ensure symmetrical opening relative to the disc over the entire wear range of the friction pads 7 (the pads of the plate 2 may be more or less worn than those of the plate 3). This system will not be disclosed in detail here.

1. A hybrid brake for a hoist, intended to cooperate with a disc of the hoist extending in a plane orthogonal to an axial direction, the hybrid brake comprising:
two plates (2, 3) extending parallel to the disc on both sides thereof, the two plates forming a clamp operable between an open-brake position where the plates are at a distance from the disc and a closed-brake position where the plates clamp the disc,
a rigid body (4, 5) comprising an upper tubular part (4), called upper half-caliper, located on one side of the disc, one of the plates (2), called upper plate, being carried by a shoe (6) mounted to slide in the axial direction in a central through recess (40) in the upper half-caliper,
a stack of spring washers (10) arranged in the central recess (40) of the upper half-caliper about a central axis (X₁₀₀) parallel to the axial direction, the stack of spring washers (10) being configured to be compressible beyond a level, called emergency braking compression, wherein said stack exerts a force on the shoe (6) corresponding to a desired emergency clamping force on the disc,
a negative actuator (8), comprising a negative piston (80) driven by a first power source, which negative piston has a face (83) whereupon a lower end of the stack of spring washers (10) rests, the negative piston (80) being mounted so as to slide in the axial direction in the central recess (40) of the upper half-caliper between an upper, open-brake position where the negative piston (80) compresses the stack of spring washers (10) beyond the emergency braking compression, and a lower, closed-brake position, where the brake is closed and where the negative piston (80) holds the stack of spring washers (10) at the emergency braking compression on one side and bears directly or indirectly on the shoe (6) on the other side, the negative piston being placed in its upper open-brake position when the first power source is activated and in its lower closed-brake position when said first power source is inactive,
a positive actuator (9) comprising a positive piston (90) driven by a second power source, the positive piston being axially slidable between an upper open-brake position where the brake is open and a lower closed-brake position where the brake is closed, the positive piston being in its upper open-brake position when the second power source is inactive and being movable to its lower closed-brake position when the second power source is activated,
the hybrid brake being characterized in that it comprises a positive piston return spring (98), configured to return the positive piston (90) to its upper open-brake position.

2. The hybrid brake according to claim 1, characterized in that:
the negative piston (80) comprises an upper cylindrical cavity (82) receiving a lower part of the stack of spring washers (10), the negative piston further comprising a lower end (85) configured to bear directly or indirectly on the shoe (6) when the negative piston is in the lower closed-brake position,
the positive piston (90) comprises a shaft (904) extending along the central axis (X₁₀₀) through the stack of spring washers (10), which shaft has a lower end configured to mate with the shoe (6) and an upper end which projects from the upper half-caliper (4) regardless of the position of the positive piston.

3. The hybrid brake according to claim 1, characterized in that the first power source is hydraulic, the negative piston (80) having an outer shoulder (84) which is oriented toward the disc (1) and which delimits, in the central recess (40) of the half-caliper, a hydraulic chamber (81) called the negative chamber.

4. The hybrid brake according to claim 1, characterized in that the first power source is electromagnetic or electromechanical.

5. The hybrid brake according to claim 1, characterized in that the second power source is hydraulic or electromechanical or electromagnetic.

6. The hybrid brake according to claim 1, characterized in that each plate (2, 3) is provided with one or more friction pads (7) and in that the brake comprises a wear compensation device (13) between the stack of spring washers (10) and the shoe (6) to compensate for friction pad wear.

7-8. (canceled)

9. The hybrid brake according to claim 1, characterized in that:
in addition to the upper half-caliper (4), the rigid body of the brake comprises a lower part (5), called the counter-caliper, located on the other side of the disc (1), the other plate (3), called the lower plate, being located on this counter-caliper (5) and being fixed relative thereto,
the brake has no actuator for braking on the counter-caliper (5) side;
the brake comprises a column (12) whereupon the rigid body (4, 5) is mounted so as to slide in the axial direction.

10. The hybrid brake according to claim 1, further comprising a microprocessor controller to which the positive actuator (9) and the negative actuator (8) of said hybrid brake are connected, the controller being configured to use the positive actuator for all dynamic service braking and for all static holding when the hoist is in service, powered on and in the absence of a fault, and to use the negative actuator for any emergency dynamic braking in the event of a fault and for any static holding when the hoist is taken out of service.

11. (canceled)

12. A hybrid brake for a hoist, intended to cooperate with a disc of the hoist extending in a plane orthogonal to an axial direction, the hybrid brake comprising:
two plates (2, 3) extending parallel to the disc on both sides thereof, the two plates forming a clamp operable between an open-brake position where the plates are at a distance from the disc and a closed-brake position where the plates clamp the disc, each plate (2, 3) provided with one or more friction pads (7)
a rigid body (4, 5) comprising an upper tubular part (4), called upper half-caliper, located on one side of the disc, one of the plates (2), called upper plate, being carried by a shoe (6) mounted to slide in the axial direction in a central through recess (40) in the upper half-caliper,
a stack of spring washers (10) arranged in the central recess (40) of the upper half-caliper about a central axis (X₁₀₀) parallel to the axial direction, the stack of spring washers (10) being configured to be compressible beyond a level, called emergency braking compression, wherein said stack exerts a force on the shoe (6) corresponding to a desired emergency clamping force on the disc,
a negative actuator (8), comprising a negative piston (80) driven by a first power source, which negative piston has a face (83) whereupon a lower end of the stack of spring washers (10) rests, the negative piston (80) being mounted so as to slide in the axial direction in the central recess (40) of the upper half-caliper between an upper, open-brake position where the negative piston (80) compresses the stack of spring washers (10) beyond the emergency braking compression, and a lower, closed-brake position, where the brake is closed and where the negative piston (80) holds the stack of spring washers (10) at the emergency braking compression on one side and bears directly or indirectly on the shoe (6) on the other side, the negative piston being placed in its upper open-brake position when the first power source is activated and in its lower closed-brake position when said first power source is inactive, the negative piston (80) comprising an upper cylindrical cavity (82) receiving a lower part of the stack of spring washers (10), the negative piston further comprising a lower end (85) configured to bear directly or indirectly on the shoe (6) when the negative piston is in the lower closed-brake position,
a positive actuator (9) comprising a positive piston (90) driven by a second power source, the positive piston being axially slidable between an upper open-brake position where the brake is open and a lower closed-brake position where the brake is closed, the positive piston being in its upper open-brake position when the second power source is inactive and being movable to its lower closed-brake position when the second power source is activated, the positive piston (90) comprising a shaft (904) extending along the central axis (X₁₀₀) through the stack of spring washers (10), which shaft has a lower end configured to mate with the shoe (6) and an upper end which projects from the upper half-caliper (4) regardless of the position of the positive piston.
the hybrid brake being characterized in that it comprises a positive piston return spring (98), configured to return the positive piston (90) to its upper open-brake position and in that the brake comprises a wear compensation device (13) between the stack of spring washers (10) and the shoe (6) to compensate for friction pad wear.

13. The hybrid brake according to claim 12, characterized in that the wear compensation device (13) comprises:
an external thread (131), called the external compensation thread, on the positive actuator shaft (904) between the lower end of the stack of spring washers (10) and the lower end (96) of the shaft,
shells (130), called compensation shells, arranged around the external compensation thread (131), each compensation shell (130) having an internally threaded face (132) complementary to the external compensation thread (131),
for each compensation shell (130), a housing (134) made in the negative piston (80) and in which said shell is housed, the housing (134) having an axial dimension greater than an axial bulk of the compensation shell increased by at least one external compensation thread pitch so that the compensation shell (130) can move axially in this housing over an axial distance of at least one external thread pitch, the housing also having a radial depth sufficient for the shell to move radially over a radial distance corresponding at least to a depth of the external thread pitch,
an elastic ring (133) surrounding the shells and exerting a centripetal radial pressure thereupon, tending to keep the compensation shells (130) pressed against the external compensation thread (131).

14. The hybrid brake according to claim 13, characterized in that the wear compensation device further comprises an actuator configured to drive the positive piston (90) in rotation and means for controlling said actuator.

15. The hybrid brake according to claim 12, characterized in that the first power source is hydraulic, the negative piston (80) having an outer shoulder (84) which is oriented toward the disc (1) and which delimits, in the central recess (40) of the half-caliper, a hydraulic chamber (81) called the negative chamber.

16. The hybrid brake according claim 12, characterized in that the first power source is electromagnetic or electromechanical.

17. The hybrid brake according to claim 12, characterized in that the second power source is hydraulic or electromechanical or electromagnetic.

18. The hybrid brake according to claim 12, characterized in that:
in addition to the upper half-caliper (4), the rigid body of the brake comprises a lower part (5), called the counter-caliper, located on the other side of the disc (1), the other plate (3), called the lower plate, being located on this counter-caliper (5) and being fixed relative thereto,
the brake has no actuator for braking on the counter-caliper (5) side;
the brake comprises a column (12) whereupon the rigid body (4, 5) is mounted so as to slide in the axial direction.

19. The hybrid brake according to claim 12, further comprising a microprocessor controller to which the positive actuator (9) and the negative actuator (8) of said hybrid brake are connected, the controller being configured to use the positive actuator for all dynamic service braking and for all static holding when the hoist is in service, powered on and in the absence of a fault, and to use the negative actuator for any emergency dynamic braking in the event of a fault and for any static holding when the hoist is taken out of service.

20. A hoist, comprising:
a disc extending in a plane orthogonal to an axial direction; and,
a hybrid brake comprising:
two plates (2, 3) extending parallel to the disc on both sides thereof, the two plates forming a clamp operable between an open-brake position where the plates are at a distance from the disc and a closed-brake position where the plates clamp the disc,
a rigid body (4, 5) comprising an upper tubular part (4), called upper half-caliper, located on one side of the disc, one of the plates (2), called upper plate, being carried by a shoe (6) mounted to slide in the axial direction in a central through recess (40) in the upper half-caliper,
a stack of spring washers (10) arranged in the central recess (40) of the upper half-caliper about a central axis (X₁₀₀) parallel to the axial direction, the stack of spring washers (10) being configured to be compressible beyond a level, called emergency braking compression, wherein said stack exerts a force on the shoe (6) corresponding to a desired emergency clamping force on the disc,
a negative actuator (8), comprising a negative piston (80) driven by a first power source, which negative piston has a face (83) whereupon a lower end of the stack of spring washers (10) rests, the negative piston (80) being mounted so as to slide in the axial direction in the central recess (40) of the upper half-caliper between an upper, open-brake position where the negative piston (80) compresses the stack of spring washers (10) beyond the emergency braking compression, and a lower, closed-brake position, where the brake is closed and where the negative piston (80) holds the stack of spring washers (10) at the emergency braking compression on one side and bears directly or indirectly on the shoe (6) on the other side, the negative piston being placed in its upper open-brake position when the first power source is activated and in its lower closed-brake position when said first power source is inactive,
a positive actuator (9) comprising a positive piston (90) driven by a second power source, the positive piston being axially slidable between an upper open-brake position where the brake is open and a lower closed-brake position where the brake is closed, the positive piston being in its upper open-brake position when the second power source is inactive and being movable to its lower closed-brake position when the second power source is activated,
the hybrid brake being characterized in that it comprises a positive piston return spring (98), configured to return the positive piston (90) to its upper open-brake position.

21. The hoist of claim 20, characterized in that:
the negative piston (80) comprises an upper cylindrical cavity (82) receiving a lower part of the stack of spring washers (10), the negative piston further comprising a lower end (85) configured to bear directly or indirectly on the shoe (6) when the negative piston is in the lower closed-brake position,
the positive piston (90) comprises a shaft (904) extending along the central axis (X₁₀₀) through the stack of spring washers (10), which shaft has a lower end configured to mate with the shoe (6) and an upper end which projects from the upper half-caliper (4) regardless of the position of the positive piston.

22. The hoist of claim 20, characterized in that each plate (2, 3) is provided with one or more friction pads (7) and in that the brake comprises a wear compensation device (13) between the stack of spring washers (10) and the shoe (6) to compensate for friction pad wear.

23. The hoist of claim 22, further comprising a microprocessor controller to which the positive actuator (9) and the negative actuator (8) of said hybrid brake are connected, the controller being configured to use the positive actuator for all dynamic service braking and for all static holding when the hoist is in service, powered on and in the absence of a fault, and to use the negative actuator for any emergency dynamic braking in the event of a fault and for any static holding when the hoist is taken out of service.
